(19) United States
(12) Patent Application Publication
(10) Pub. No.: US 2022/0318275 A1
(43) Pub. Date: Oct. 6, 2022

(54) SEARCH METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Wei Jia, Beijing (CN); Dai Dai, Beijing (CN); Xinyan Xiao, Beijing (CN)

(73) Assignee: BEIJING BAIDU NETCOM SCIENCE TECHNOLOGY CO., LTD., Beijing (CN)

(21) Appl. No.: 17/808,358

(22) Filed: Jun. 23, 2022

(30) Foreign Application Priority Data
Jun. 30, 2021 (CN) 202110738785.2

(51) Int. Cl. G06F 16/28; G06F 16/2457; G06K 9/62

(52) U.S. Cl. CPC G06F 16/285; G06F 16/288; G06F 16/24573; G06K 9/6256

(57) ABSTRACT

The disclosure provides a search method, an electronic device and a storage medium. The method includes: obtaining a query statement; determining a correlation between the query statement and a candidate result by matching the query statement with a first structured data set corresponding to the candidate result in a search database, in which the first structured data set is generated by performing information extraction on the candidate result by a structured information extraction model generated by training; and determining, based on the correlation, a target search result corresponding to the query statement.

### CROSS-REFERENCE TO RELATED APPLICATION

This application claims priority to and benefits of Chinese Patent Application Serial No. 202110738785.2, filed the State Intellectual Property Office of P. R. China on Jun. 30, 2021, the entire content of which is incorporated herein by reference.

### TECHNICAL FIELD

The disclosure relates to the field of data processing technology, specially to the field of artificial intelligence technology such as big data processing, deep learning and knowledge graph, and in particular to a search method, an electronic device and a storage medium.

### BACKGROUND

With the continuous development and improvement, artificial intelligence technology has played an extremely important role in various fields related to human daily life. For example, artificial intelligence technology has made significant progress in the field of web search. Currently, how to quickly and accurately obtain a target search result has become a heat research direction.

### SUMMARY

The disclosure provides a search method. The method includes: obtaining a query statement; determining a correlation between the query statement and a candidate result by matching the query statement with a first structured data set corresponding to the candidate result in a search database, in which the first structured data set is generated by performing information extraction on the candidate result by a structured information extraction model generated by training; and determining, based on the correlation, a target search result corresponding to the query statement.

The disclosure provides an electronic device. The electronic device includes: at least one processor and a memory coupled in communication with the at least one processor. The memory stores instructions executable by the at least one processor, and when the instructions are executed by the at least one processor, the at least one processor is caused to execute the method according to the first aspect.

The disclosure provides a non-transitory computer-readable storage medium storing computer instructions. The computer instructions are configured to cause a computer to execute the method according to the first aspect.

It should be understood that the content described in this section is not intended to identify the key or important features of the embodiments of the disclosure, nor is it intended to limit the scope of the disclosure. Additional features of the disclosure will be easily understood through the following description.

### BRIEF DESCRIPTION OF THE DRAWINGS

The drawings are used to better understand the disclosure and do not constitute a limitation of the disclosure, in which:

FIG. 1 is a flowchart of a search method according to an embodiment of the disclosure.

FIG. 2 is a flowchart of a search method according to an embodiment of the disclosure.

FIG. 3 is a block diagram of a search apparatus according to an embodiment of the disclosure.

FIG. 4 is a block diagram of a search apparatus according to an embodiment of the disclosure.

FIG. 5 is a schematic diagram of an electronic device used to implement the search method according to an embodiment of the disclosure.

### DETAILED DESCRIPTION

The exemplary embodiments of the disclosure are described below in combination with the accompanying drawings, which include various details of the embodiments of the disclosure to aid in understanding, and should be considered merely exemplary. Therefore, those skilled in the art should know that various changes and modifications can be made to the embodiments described herein without departing from the scope and spirit of the disclosure. For the sake of clarity and brevity, descriptions of well-known features and structures have been omitted from the following description.

The embodiments of the disclosure relate to the fields of artificial intelligence technology such as big data processing, deep learning and knowledge graphs.

Artificial Intelligence (AI) is a new technological science that studies and develops theories, methods, technologies and application systems used to simulate, extend and expand human intelligence.

Big data processing refers to the collection of a large amount of data through multiple channels, and the in-depth data mining and analysis through the cloud computing technology, to ensure that the rules and characteristics between the data can be found in time, and the value of the data can be summarized and concluded. Big data processing technology is of great significance for understanding data characteristics and predicting development trends.

Deep learning is to learn the internal rules and representation levels of sample data. The information obtained in the learning process is of great help to the interpretation of data such as text, images and sounds. The ultimate goal of deep learning is to allow machines to have the ability to analyze and learn like humans, and to recognize data such as text, images, and sounds.

The knowledge graph is essentially a semantic network, a graph-based data structure composed of nodes and edges. In the knowledge graph, each node represents an entity that exists in the real world, and each edge is a relationship between the entities. Traditionally, the knowledge graph is a relational network obtained by connecting all different types of information together. The knowledge graph provides the ability to analyze problems from the perspective of “relationship”.

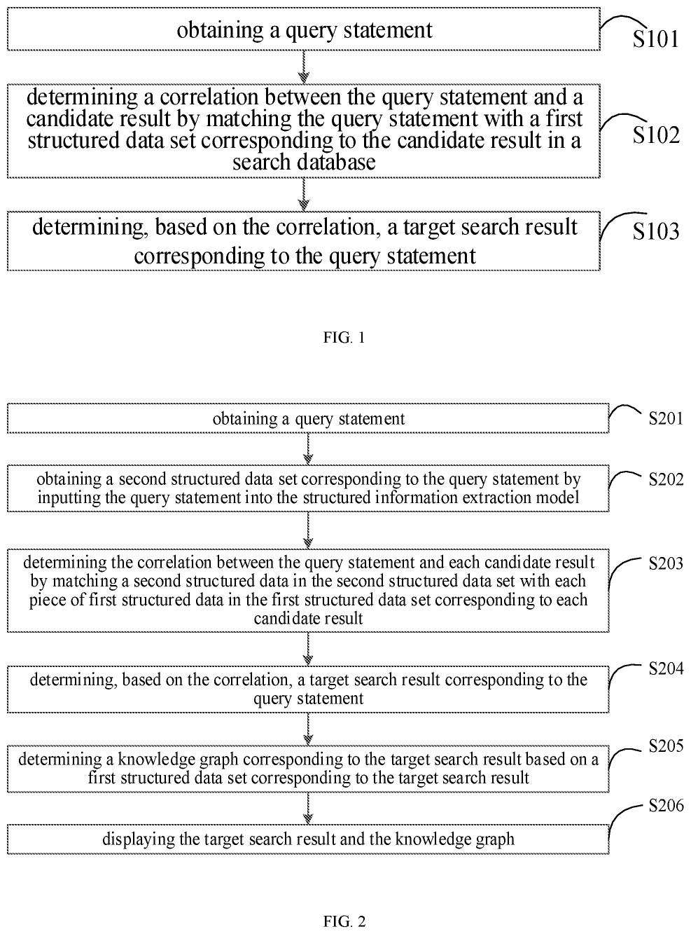

FIG. 1 is a flowchart of a search method according to an embodiment of the disclosure.

It should be noted that the execution subject of the search method in this embodiment is a search apparatus, which can be implemented by software and/or hardware. The apparatus can be configured in an electronic device. The electronic device can include, but is not limited to, a terminal and a server.

As shown in FIG. 1, the search method includes the following steps.

In step S101, a query statement is obtained.

The query statement may be a text statement directly input by the user and used to obtain a search result, or may be a statement extracted from data such as an audio and an image uploaded by the user, which is not limited in the disclosure.

In step S102, a correlation between the query statement and a candidate result is determined by matching the query statement with a first structured data set corresponding to the candidate result in a search database.

Each piece of first structured data set is generated by performing information extraction on the corresponding candidate result by a structured information extraction model generated by training.

In some embodiments, key character segmentations contained in the query statement can be obtained first, and then each key character segmentation can be matched with each piece of first structured data in the first structured data set corresponding to the candidate result, to determine the correlation between the query statement and the candidate result based on a matching degree between each key character segmentation and each piece of first structured data.

In some embodiments, the query statement is matched with the candidate result according to the Euclidean distance and Manhattan distance between the query statement and the first structured data set corresponding to the candidate result, to obtain the correlation between the query statement and the candidate result.

In some embodiments, in the disclosure, the structured information extraction model may be trained through the following process.

(1) A training data set including multi-modality sample data and labeled structured data corresponding to the sample data is received.

The multi-modality sample data may include various types of data such as texts, audios, images, videos and tables, which are not limited in the disclosure.

For example, if the sample data is text data, such as “influenza is commonly known as cold”, the corresponding labeled structured data can be “[influenza, is commonly known as, cold]”; or, the sample data is audio data, and the text information extracted from the audio data is “Cherry tree is a shallow-rooted fruit tree”, the corresponding labeled structured data can be “[cherry tree, a shallow-rooted fruit tree]”.

It should be noted that the foregoing examples are only simple examples, and cannot be used as a limitation on the sample data and the labeled structured data in the embodiments of the disclosure.

(2) Predicted structured data corresponding to the sample data is obtained by inputting the sample data into an initial network model.

It should be noted that the initial network model is used to train a model that can process any type of input data to output its corresponding structured data, that is, the initial network model can process both text data and non-text data. Therefore, in the disclosure, when training the initial network model, the initial network model can be divided into two parts. The first part is configured to convert any non-text data into text data, and the second part is configured to process the text data to output its corresponding structured data.

(3) The structured information extraction model is obtained by modifying the initial network model based on difference between the predicted structured data and the corresponding labeled structured data.

It is understandable that if the initial network model is divided into two parts, in order to speed up the training of the model, the training of the initial network model in this disclosure can also be divided into two parts and carried out simultaneously. The two parts of the network are trained separately, and then joint training is performed on the two parts of the network.

The first part of the network may include a first encoder and a first decoder. The first encoder is configured to encode the multi-modality sample data to obtain the text data corresponding to the multi-modality sample data. The first decoder is configured to decode the text data to output reference multi-modality sample data. Then, based on the difference between the reference multi-modality sample data output by the first decoder and the original multi-modality sample data, the first encoder and the first decoder can be modified and trained.

In addition, the second part of the network may include a second encoder and a second decoder. The second encoder is configured to encode the text data, and the second decoder is configured to decode the encoded text data to obtain the predicted structured data corresponding to the text data. Based on the difference between the predicted structured data and the labeled structured data, the second encoder and the second decoder can be modified and trained.

It should be noted that in the disclosure, the second encoder and the second decoder can use the same network structure to share network parameters, so that the two can enhance each other, so that the effect of the second part of the network can be improved.

Then, the first part and the second part can be jointly trained. The first encoder encodes the multi-modality sample data to obtain the text data corresponding to the multi-modality sample data, and then the second encoder encodes the text data, and the encoded text data is decoded by the second decoder, to obtain the predicted structured data corresponding to the text data. Afterwards, based on the difference between the predicted structured data and the labeled structured data, the first encoder, the second encoder and the second decoder can be modified and trained.

In step S103, a target search result corresponding to the query statement is determined based on the correlation.

In some embodiments, a candidate result with the greatest correlation value to the query statement can be selected from multiple candidate results as the target search result of the query statement.

In some embodiments, multiple candidate results may be sorted according to the correlation in a descending order, and then the first N candidate results may be selected as the target search results, where N is a positive integer.

It is understandable that, in the disclosure, the query statement is matched with the structured data in all the structured data sets corresponding to the candidate results during the search process, so as to ensure that the matching result is more comprehensive and accurate.

In the embodiments of the disclosure, the query statement is obtained, the correlation between the query statement and the candidate result is determined by matching the query statement with the first structured data set corresponding to the candidate result in the search database. Based on the correlation, the target search result corresponding to the query statement is determined. Therefore, the target search result is determined according to the correlation between the query statement and the first structured data set corresponding to each candidate result, thereby improving the searching accuracy and reliability.

From the above analysis, it can be known that in the disclosure, the target search result can be determined according to the correlation between the query statement and the first structured data set corresponding to each candidate result. In a possible implementation, when the search result is displayed, the display style of the search result can also be determined as desired. The above process will be described in detail below with reference to FIG. 2.

FIG. 2 is a flowchart of a search method according to an embodiment of the disclosure. As shown in FIG. 2, the search method includes the following steps.

In step S201, a query statement is obtained.

The specific implementation form of step S201 can refer to the detailed description of the other embodiments in the disclosure, which will not be repeated here.

In step S202, a second structured data set corresponding to the query statement is obtained by inputting the query statement into the structured information extraction model.

For example, if the query statement is “Puppy is a mammal”, the second structured data set can be “[Puppy, is, a mammal]”. Or, if the query statement is “one meter is one hundred centimeters”, the second structured data set may be “[one meter, is, one hundred centimeters]”.

It should be noted that the foregoing examples are only simple examples, and cannot be used as a limitation on the query statement and the second structured data set in the embodiments of the disclosure.

In step S203, a correlation between the query statement and a candidate result is determined by matching a second structured data in the second structured data set with each piece of first structured data corresponding to the candidate result.

In some embodiments, the second structured data is matched with each piece of first structured data.

In some embodiments, since the structured data may include relational data and key-value pairs, in order to minimize the matching complexity between the structured data, the type of the first structured data and the type of the second structured data can be further determined. Then, for each piece of second structured data, the second structured data is matched with a first structured data of the same type as the second structured data, to determine the correlation between the query statement and each candidate result.

Relational data represent the relationship between the query statement and the subject, predicate, and object in the candidate result. For example, a candidate result is “influenza is commonly known as cold”, the subject is “influenza”, the predicate is “is commonly known as”, and the object is “cold”, the first structured data set is [influenza, is commonly known as, cold].

The key-value pair represent the keywords in the candidate result and the query statement, and the value corresponding to the keywords. For example, if the candidate result is “Cherry tree is a shallow-rooted fruit tree”, the keyword is “Cherry tree”, and the value corresponding to the keyword is “shallow-rooted fruit tree”, the first structured data set is [Cherry tree, a shallow-rooted fruit tree].

For example, if any second structured data in the second structured data set corresponding to the query statement is relational data, then the second structured data can be matched with only the relational data in the first structured data set. The second structured data set is [subject 1, predicate 1, object 1], the first structured data set corresponding to a certain candidate result includes the two relational data, namely [subject 2, predicate 2, object 2], and [subject 3, predicate 3, object 3], then “subject 1” in the second structured data set can be matched with “subject 2” and “subject 3” respectively, “predicate 1” is matched with “predicate 2” and “predicate 3” respectively, and “object 1” is matched with “object 2” and “object 3” respectively. Finally, according to the matching result corresponding to each piece of second structured data, the correlation between the query statement and the candidate result is determined.

In the embodiments of the disclosure, the second structured data in the query statement is matched with the first structured data of the same type, thereby shortening the matching time between the query statement and each candidate result, and further improving the efficiency of obtaining the target search result.

In step S204, based on the correlation, a target search result corresponding to the query statement is determined.

The specific implementation form of the above step S204 may refer to the detailed description of the other embodiments in the disclosure, which will not be repeated here.

In step S205, a knowledge graph corresponding to the target search result is determined based on a first structured data set corresponding to the target search result.

The knowledge graph displays the key information in the target search result and the relationship between the key information.

In some embodiments, after determining the first structured data set corresponding to each candidate result, the knowledge graph corresponding to each candidate result may be generated according to the corresponding first structured data set.

It should be noted that the knowledge graph corresponding to the candidate result can also be generated just after the first structured data set corresponding to the candidate result is determined, and then the knowledge graph corresponding to the candidate result can be directly called when the candidate result is determined as the target search result.

In step S206, the target search result and the knowledge graph are displayed.

In the disclosure, the knowledge graph can more visually reflect the relationship between the knowledge, thus, after the target search result is determined, in order to minimize the time for users to read the search result to extract the key information, the knowledge graph corresponding to the search result can be displayed at the same time.

In some embodiments, the target search result and the knowledge graph may be displayed when a modality of the data in the target search result meet a preset condition.

For example, if the target search result is plain text data, and the text length is greater than a preset length threshold, the target search result and the corresponding knowledge graph can be displayed, the user can selectively decide whether to read the knowledge graph or the target search result, and reading the knowledge graph corresponding to the target search result can save the time for the users to read the target search result and extract the key information.

In some embodiments, if the target search result includes video-modal data, the target search result and the corresponding knowledge graph can be displayed at the same time, and the user can selectively read the target search result or the corresponding knowledge graph, or the user can also follow the knowledge graph to watch the video data selectively to save the user's time to watch the video data.

It should be noted that the foregoing examples are only simple examples, and cannot be used as a limitation on the target search result in the embodiments of the disclosure.

In the embodiments of the disclosure, after the target search result of the query statement is determined, the knowledge graph corresponding to the target search result is displayed. The user can obtain the key information in the target search result according to the knowledge graph, which saves time for the users to extract the key information from the target search result.

In the embodiments of the disclosure, each piece of the second structured data in the second structured data set corresponding to the query statement is matched with each piece of the first structured data corresponding to the candidate result, to obtain the target search result corresponding to the query statement. Finally, the target search result and the knowledge graph are displayed at the same time, which not only further improves the accuracy of the target search result, but also saves the users' the time to extract the key information from the target search result.

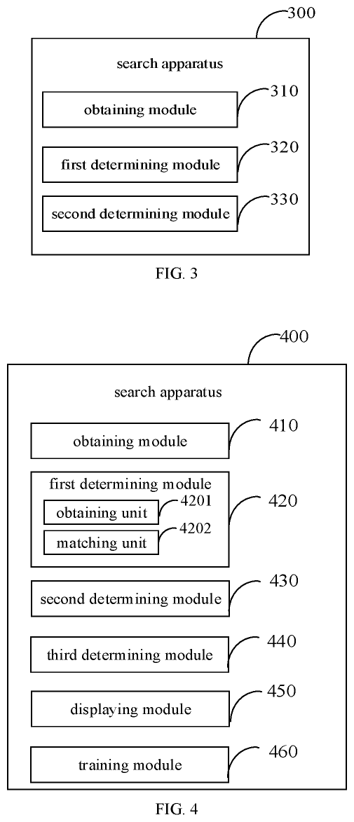

FIG. 3 is a block diagram of a search apparatus according to an embodiment of the disclosure. As shown in FIG. 3, the search apparatus 300 includes: an obtaining module 310, a first determining module 320, and a second determining module 330.

The obtaining module 310 is configured to obtain a query statement.

The first determining module 320 is configured to determine a correlation between the query statement and a candidate result by matching the query statement with a first structured data set corresponding to the candidate result in a search database, in which the first structured data set is generated by performing information extraction on the candidate result by a structured information extraction model generated by training.

The second determining module 330 is configured to determine, based on the correlation, a target search result corresponding to the query statement.

It should be noted that the foregoing explanation of the search method is also applicable to the search apparatus of this embodiment, and will not be repeated here.

With the search apparatus according to the embodiments of the disclosure, the query statement is obtained, the correlation between the query statement and the candidate result is determined by matching the query statement with the first structured data set corresponding to the candidate result in the search database. Based on the correlation, the target search result corresponding to the query statement is determined. Therefore, the target search result is determined according to the correlation between the query statement and the first structured data set corresponding to each candidate result, thereby improving the searching accuracy and reliability.

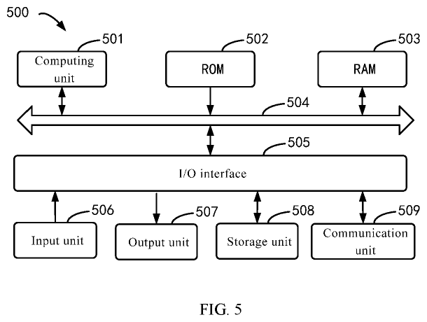

In some embodiment, as shown in FIG. 4, FIG. 4 is a block diagram of a search apparatus 400 according to another embodiment of the disclosure. The search apparatus 400 includes: an obtaining module 410, a first determining module 420, a second determining module 430, a third determining module 440, a displaying module 450 and a training module 460. The first determining module 420 includes: an obtaining unit 4201 and a matching unit 4202.

The obtaining unit 4201 is configured to obtain a second structured data set corresponding to the query statement by inputting the query statement into the structured information extraction model.

The matching unit 4202 is configured to match a second structured data in the second structured data set in the first structured data set with a first structured data corresponding to the candidate result.

In a possible implementation, the matching unit 4202 is configured to: determine a type of the first structured data and a type of the second structured data; and match the second structured data with a first structured data of the same type.

In a possible implementation, the search apparatus 400 further includes: the third determining module 440 and the displaying module 450.

The third determining module 440 is configured to determine a knowledge graph corresponding to the target search result based on a first structured data set corresponding to the target search result.

The displaying module 450 is configured to display the target search result and the knowledge graph.

In a possible implementation, the displaying module 450 is configured to: display the target search result and the knowledge graph in response to a modality of data in the target search result satisfying a predetermined condition.

In a possible implementation, the search apparatus 400 further includes the training module 460.

The training module 460 is configured to: receive a training data set including multi-modality sample data and labeled structured data corresponding to the sample data; obtain predicted structured data corresponding to the sample data by inputting the sample data into an initial network model; and obtain the structured information extraction model by modifying the initial network model based on difference between the predicted structured data and the corresponding labeled structured data.

It can be understood that the search apparatus 400 in FIG. 4 of this embodiment and the search apparatus 300 in the above embodiments may have the same function and structure, the obtaining module 410 and the obtaining module 310 in the above embodiments may have the same function and structure, the first determining module 420 and the first determining module 320 in the above embodiments may have the same function and structure, the second determining module 430 and the second determining module 330 in the above embodiments may have the same function and structure.

It should be noted that the foregoing explanation of the search method is also applicable to the search apparatus of this embodiment, and will not be repeated here.

In the embodiments of the disclosure, each piece of second structured data in the second structured data set corresponding to the query statement is matched with each piece of first structured data corresponding to the candidate result, to obtain the target search result corresponding to the query statement. Finally, the target search result and the corresponding knowledge graph are displayed at the same time, which not only improves the accuracy of the target search result, but also saves time for users to extract the key information from the target search result.

According to the embodiments of the disclosure, the disclosure also provides an electronic device, a readable storage medium and a computer program product.

FIG. 5 is a block diagram of an electronic device 500 configured to implement the method according to embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 5, the device 500 includes a computing unit 501 performing various appropriate actions and processes based on computer programs stored in a read-only memory (ROM) 502 or computer programs loaded from the storage unit 508 to a random access memory (RAM) 503. In the RAM 503, various programs and data required for the operation of the device 500 are stored. The computing unit 501, the ROM 502, and the RAM 503 are connected to each other through a bus 504. An input/output (I/O) interface 505 is also connected to the bus 504.

Components in the device 500 are connected to the I/O interface 505, including: an inputting unit 506, such as a keyboard, a mouse; an outputting unit 507, such as various types of displays, speakers; a storage unit 508, such as a disk, an optical disk; and a communication unit 509, such as network cards, modems, wireless communication transceivers, and the like. The communication unit 509 allows the device 500 to exchange information/data with other devices through a computer network such as the Internet and/or various telecommunication networks.

The computing unit 501 may be various general-purpose and/or dedicated processing components with processing and computing capabilities. Some examples of computing unit 501 include, but are not limited to, a central processing unit (CPU), a graphics processing unit (GPU), various dedicated artificial intelligence (AI) computing chips, various computing units that run machine learning model algorithms, and a digital signal processor (DSP), and any appropriate processor, controller and microcontroller. The computing unit 501 executes the various methods and processes described above, such as the search method. For example, in some embodiments, the search method may be implemented as a computer software program, which is tangibly contained in a machine-readable medium, such as the storage unit 508. In some embodiments, part or all of the computer program may be loaded and/or installed on the device 500 via the ROM 502 and/or the communication unit 509. When the computer program is loaded on the RAM 503 and executed by the computing unit 501, one or more steps of the search method described above may be executed. Alternatively, in other embodiments, the computing unit 501 may be configured to perform the search method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), erasable programmable read-only memories (EPROM or flash memory), fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and Block-chain network.

The computer system may include a client and a server. The client and server are generally remote from each other and interacting through a communication network. The client-server relation is generated by computer programs running on the respective computers and having a client-server relation with each other. The server can be a cloud server, also known as a cloud computing server or a cloud host, which is a host product in the cloud computing service system, to solve the traditional physical host with a Virtual Private Server (VPS) service, which has the defects of difficult management and weak business expansibility. The server can also be a server for a distributed system, or a server that incorporates a blockchain.

According to the embodiments of the disclosure, the query statement is obtained, the correlation between the query statement and the candidate result is determined by matching the query statement with the first structured data set corresponding to the candidate result in the search database. Based on the correlation, the target search result corresponding to the query statement is determined. Therefore, the target search result is determined according to the correlation between the query statement and the first structured data set corresponding to each candidate result, thereby improving the searching accuracy and reliability.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A search method, comprising.
obtaining a query statement;
determining a correlation between the query statement and a candidate result by matching the query statement with a first structured data set corresponding to the candidate result in a search database, wherein the first structured data set is generated by performing information extraction on the candidate result by a structured information extraction model generated by training; and
determining, based on the correlation, a target search result corresponding to the query statement.

2. The method of claim 1, wherein matching the query statement with the first structured data set corresponding to the candidate result in the search database comprises:
obtaining a second structured data set corresponding to the query statement by inputting the query statement into the structured information extraction model; and
matching a second structured data in the second structured data set with each piece of first structured data in the first structured data set corresponding to the candidate result.

3. The method of claim 2, wherein the structured data contains relational data and key-value pairs, and matching the second structured data in the second structured data set with each piece of first structured data in the first structured data set corresponding to the candidate result comprises:
determining a type of the first structured data and a type of the second structured data; and
matching the second structured data with a first structured data of the same type.

4. The method of claim 1, after determining the target search result corresponding to the query statement, further comprising:
determining a knowledge graph corresponding to the target search result based on a first structured data set corresponding to the target search result; and
displaying the target search result and the knowledge graph.

5. The method of claim 4, wherein displaying the target search result and the knowledge graph comprises:
displaying the target search result and the knowledge graph in response to a modality of data in the target search result satisfying a predetermined condition.

6. The method according to claim 1, further comprising:
receiving a training data set comprising multi-modality sample data and labeled structured data corresponding to the sample data;
obtaining predicted structured data corresponding to the sample data by inputting the sample data into an initial network model; and
obtaining the structured information extraction model by modifying the initial network model based on difference between the predicted structured data and the corresponding labeled structured data.

7. An electronic device, comprising:
at least one processor; and
a memory coupled in communication with the at least one processor; wherein,
the memory stores instructions executable by the at least one processor, and when the instructions are executed by the at least one processor, the at least one processor is caused to execute a search method, the method comprising:
obtaining a query statement;
determining a correlation between the query statement and a candidate result by matching the query statement with a first structured data set corresponding to the candidate result in a search database, wherein the first structured data set is generated by performing information extraction on the candidate result by a structured information extraction model generated by training; and
determining, based on the correlation, a target search result corresponding to the query statement.

8. The electronic device of claim 7, wherein matching the query statement with the first structured data set corresponding to the candidate result in the search database comprises:
obtaining a second structured data set corresponding to the query statement by inputting the query statement into the structured information extraction model; and
matching a second structured data in the second structured data set with each piece of first structured data in the first structured data set corresponding to the candidate result.

9. The electronic device of claim 8, wherein the structured data contains relational data and key-value pairs, and matching the second structured data in the second structured data set with each piece of first structured data in the first structured data set corresponding to the candidate result comprises:
determining a type of the first structured data and a type of the second structured data; and
matching the second structured data with a first structured data of the same type.

10. The electronic device of claim 7, wherein after determining the target search result corresponding to the query statement, the method further comprises:
determining a knowledge graph corresponding to the target search result based on a first structured data set corresponding to the target search result; and
displaying the target search result and the knowledge graph.

11. The electronic device of claim 10, wherein displaying the target search result and the knowledge graph comprises:
displaying the target search result and the knowledge graph in response to a modality of data in the target search result satisfying a predetermined condition.

12. The electronic device according to claim 7, wherein the method further comprises:
receiving a training data set comprising multi-modality sample data and labeled structured data corresponding to the sample data;
obtaining predicted structured data corresponding to the sample data by inputting the sample data into an initial network model; and
obtaining the structured information extraction model by modifying the initial network model based on difference between the predicted structured data and the corresponding labeled structured data.

13. A non-transitory computer-readable storage medium storing computer instructions, wherein the computer instructions are configured to make a computer execute a search method, the method comprising:
obtaining a query statement;
determining a correlation between the query statement and a candidate result by matching the query statement with a first structured data set corresponding to the candidate result in a search database, wherein the first structured data set is generated by performing information extraction on the candidate result by a structured information extraction model generated by training; and
determining, based on the correlation, a target search result corresponding to the query statement.

14. The non-transitory computer-readable storage medium of claim 13, wherein matching the query statement with the first structured data set corresponding to the candidate result in the search database comprises:
obtaining a second structured data set corresponding to the query statement by inputting the query statement into the structured information extraction model; and
matching a second structured data in the second structured data set with each piece of first structured data in the first structured data set corresponding to the candidate result.

15. The non-transitory computer-readable storage medium of claim 14, wherein the structured data contains relational data and key-value pairs, and matching the second structured data in the second structured data set with each piece of first structured data in the first structured data set corresponding to the candidate result comprises:
determining a type of the first structured data and a type of the second structured data; and
matching the second structured data with a first structured data of the same type.

16. The non-transitory computer-readable storage medium of claim 13, wherein after determining the target search result corresponding to the query statement, the method further comprises:
determining a knowledge graph corresponding to the target search result based on a first structured data set corresponding to the target search result; and
displaying the target search result and the knowledge graph.

17. The non-transitory computer-readable storage medium of claim 16, wherein displaying the target search result and the knowledge graph comprises:
displaying the target search result and the knowledge graph in response to a modality of data in the target search result satisfying a predetermined condition.

18. The non-transitory computer-readable storage medium according to claim 13, wherein the method further comprises:
receiving a training data set comprising multi-modality sample data and labeled structured data corresponding to the sample data;
obtaining predicted structured data corresponding to the sample data by inputting the sample data into an initial network model; and
obtaining the structured information extraction model by modifying the initial network model based on difference between the predicted structured data and the corresponding labeled structured data.
